(19) United States
(12) Patent Application Publication
(10) Pub. No.: US 2009/0029704 A1
(43) Pub. Date: Jan. 29, 2009

(54) METHOD AND APPARATUS FOR DISCOVERING LOCATION OF INFORMATION SERVER AND METHOD AND APPARATUS FOR RECEIVING HANDOVER INFORMATION USING LOCATION OF INFORMATION SERVER

(75) Inventor: Soo-hong PARK, Gwangju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/135,702

(22) Filed: Jun. 9, 2008

Related U.S. Application Data
(60) Provisional application No. 60/952,058, filed on Jul. 26, 2007.

(30) Foreign Application Priority Data
Sep. 14, 2007 (KR) 10-2007-0093853

(51) Int. Cl. H04Q 7/20

(52) U.S. Cl. 455/436; 455/456.1

(57) ABSTRACT

A method and apparatus for discovering a location of an information server using a router advertisement (RA) message that is utilized to automatically set an address in an IPv6 environment and receiving information necessary for determining mobility by using the location of the information server.

This application claims priority from U.S. Provisional Patent Application No. 60/952,058, filed on Jul. 26, 2007, in the US Patent and Trademark Office, and Korean Patent Application No. 10-2007-0093853, filed on Sep. 14, 2007, in the Korean Intellectual Property Office, the disclosure of which are incorporated herein in their entirety by reference.

### BACKGROUND OF THE INVENTION

1. Field of the Invention

Methods and apparatuses consistent with the present invention relate to mobile communication, and more particularly, to discovering a location of an information server and receiving handover information using the location of the information server.

2. Description of the Related Art

A variety of wireless environments currently need mobility support between technologies. To this end, the 802.21 media independent handover (MIH) is being developed with the IEEE 802 standard. The MIH is divided into an information service (IS), an event service (ES), and a command service (CS). The IS is used to identify what type of wireless technologies are around mobile terminals. The IS and an information server coexist.

It is necessary to discover a location of an information server over a network in order to acquire information required by a mobile terminal. However, the IEEE 802.21 standard does not have developed a technology for identifying how to discover the information server, i.e., how to discover the location of the information server over the network. Even if the IEEE 802.21 standard develops the technology for identifying how to discover the location of the information server over the network, the technology defines only how to receive handover information from the information server. In more detail, it is assumed that the mobile terminal is informed of the location of the information server over the network.

A method of discovering the location of the information server by using a router advertisement (RA) message that is utilized to automatically set an address in an Internet protocol version 6 (IPv6) environment is provided.

### SUMMARY OF THE INVENTION

The present invention provides a method and apparatus for discovering a location of an information server over a network by using a router advertisement (RA) message, and a computer readable recording medium having embodied thereon a computer program for executing the method.

The present invention also provides a method and apparatus for discovering a location of an information server over a network by using an RA message, a method and apparatus for receiving handover information using the location of the information server, and a computer readable recording medium having embodied thereon a computer program for executing the method of receiving the handover information.

According to an aspect of the present invention, there is provided a method of discovering a location of an information server that provides a mobile node with handover information over a network, the method comprising: receiving a router advertisement (RA) message including location information on the information server over the network; and extracting the location information on the information server over the network from the RA message.

According to another aspect of the present invention, there is provided an apparatus for discovering a location of an information server that provides handover information over a network, the apparatus comprising: an RA receiving unit which receives an RA message including location information on the information server over the network; and a location information extracting unit which extracts the location information on the information server over the network from the RA message.

According to another aspect of the present invention, there is provided a method of receiving handover information in a mobile node, the method comprising: receiving an RA message including location information on an information server that provides the handover information over the network; extracting the location information on the information server over the network from the RA message; accessing the information server by using the location information on the information server; and receiving the handover information from the information server.

According to another aspect of the present invention, there is provided an apparatus for receiving handover information comprising: an RA receiving unit receiving an RA message including location information on an information server that provides the handover information over the network; a location information extracting unit which extracts the location information on the information server over the network from the RA message; and a handover information receiving unit which accesses the information server by using the location information on the information server, and which receives the handover information from the information server.

### BRIEF DESCRIPTION OF THE DRAWINGS

The above and other features and advantages of the present invention will become apparent and more readily appreciated from the following description of the exemplary embodiments, taken in conjunction with the accompanying drawings of which:

FIG. 1 illustrates a handover performed by a mobile node according to an exemplary embodiment of the present invention;

FIG. 2 illustrates a process of a mobile node receiving handover information from an information server according to an exemplary embodiment of the present invention;

FIG. 3 is a block diagram of an apparatus for discovering a location of an information server according to an exemplary embodiment of the present invention;

FIG. 4 is a flowchart of a method of discovering a location of an information server according to an exemplary embodiment of the present invention;

FIG. 5 is a flowchart of a method of discovering a location of an information server according to another exemplary embodiment of the present invention;

FIG. 6 illustrates a mobile communication environment in which a location of an information server is discovered according to an exemplary embodiment of the present invention;

FIG. 7 is a block diagram of an apparatus for receiving handover information according to an exemplary embodiment of the present invention;

FIG. 8 is a flowchart of a method of receiving handover information according to an exemplary embodiment of the present invention; and

FIG. 9 is a diagram of a format of a router advertisement (RA) message according to an exemplary embodiment of the present invention.

### DETAILED DESCRIPTION OF EXEMPLARY EMBODIMENTS OF THE INVENTION

Hereinafter, exemplary embodiments of the present invention will now be described more fully with reference to the accompanying drawings.

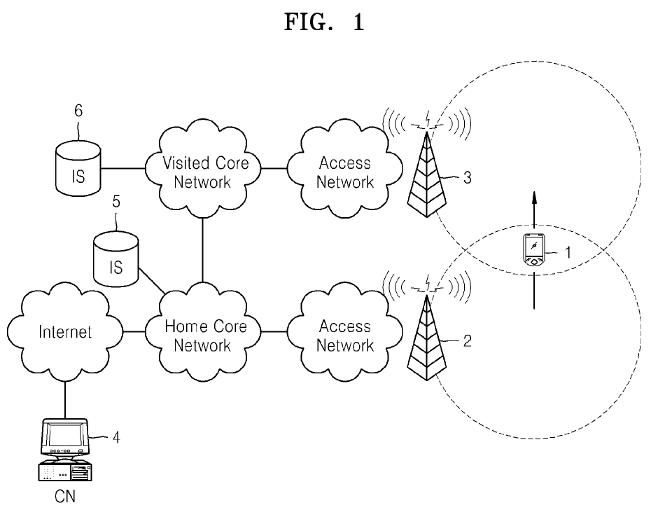

FIG. 1 illustrates a handover performed by a mobile node according to an exemplary embodiment of the present invention. Referring to FIG. 1, a mobile communication environment comprises a mobile node MN 1, points of attachment PoAs 2 and 3, a correspondent node CN 4, information servers ISs 5 and 6, and a plurality of networks. It will be understood by those of ordinary skill in the art that a variety of other topologies are possible besides the network topology illustrated in FIG. 1.

The MN 1 uses the mobile communication environment. When the MN 1 starts to use mobile communication, the MN 1 registers a home address HoA in a home agent over a home network. When the MN 1 moves to another network, the MN 1 obtains a care of address CoA from a foreign agent FA that is an agent of another network. The MN 1 sends the CoA to the home agent to register it in the HoA. The home agent allows the CoA and the HoA to correspond to each other, which is called address binding.

When the MN 1 moves to another network and obtains a CoA of the other network, the MN 1 sends the CoA to the home agent. The home agent cancels previous address binding and performs binding of the HoA and the CoA, which is called a binding update BU.

The CN 4 must be informed of an address of the MN 1 in order to transmit data packet to the MN 1. Since the CN 4 is informed of the HoA, the CN 4 sets the HoA as a receiving address, and transmits the data packet to the home agent. Since the home agent is informed of the CoA corresponding to the HoA, the home agent sets the CoA as the receiving address and transmits the data packet to the MN 1 over the networks.

The PoAs 2 and 3 connect the MN 1 to the networks. Examples of the PoAs 2 and 3 are an access point AP, a base station BS, etc. However, the PoAs 2 and 3 are not limited thereto. The PoAs 2 and 3 can perform data transmission between the MN 1 and networks.

A handover is performed when the MN 1 moves to another network. Referring to FIG. 1, the MN 1 moves from a network area where data communication is performed through the current PoA 2 to another network area where data communication is performed through the PoA 3.

The MN 1 receives information on a new network and on the PoA 3 of the new network through the current PoA 2 from ISs 5 and 6. When the current PoA 2 serves as an IS, the MN 1 can receive the information on the new network and on the PoA 3. The MN1 is informed of a network protocol used in the new network, a service supported by the new network, etc. by using the received information, in order to prepare for the network protocol, the service, etc. This type of information is referred to as handover information.

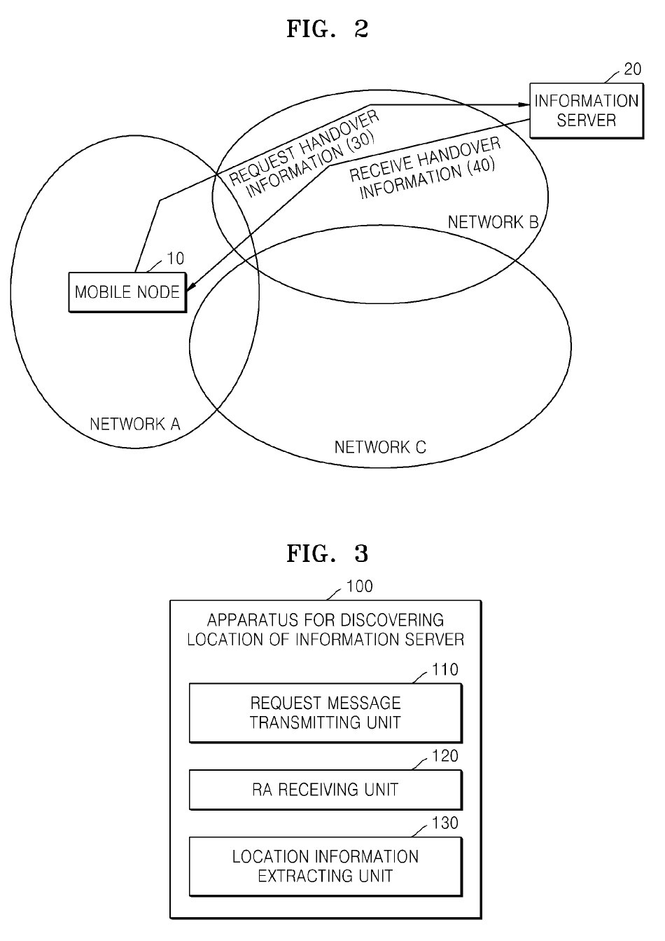

FIG. 2 illustrates a process of a mobile node 10 receiving handover information from an information server according to an exemplary embodiment of the present invention. Referring to FIG. 2, the MN 10 moves from a network A to a network B or C.

The MN 10 has a function of a media independent handover (MIH). The MN 10 sends a handover information request message to an IS 20 (Operation 30), and receives the handover information from the IS 20 (Operation 40). The MN 10 performs a handover to a network B or C using the received handover information.

The IS 20 has several pieces of information necessary for the handover. The handover information includes information on the network B or C. The IS 20 receives the handover information request message from the MN 10 and transmits the handover information to the MN 10 in Operation 40.

An MN grasps an IS that can be connected to a network to which the MN belongs, and sends a message requesting information necessary for its mobility to the IS. The IS receives the information request message from the MN and transmits a message including necessary information from among information on networks located around the MN in response to the information request message. The MN receives the response message from the IS, extracts necessary information from the message, stores the information, and decides on a necessary movement using the information.

However, since the MN frequently moves over networks and a plurality of ISs exist, the MN needs a method of determining an IS that transmits information necessary for the MN. The IEEE 802.21 standard does not have developed a technology for identifying how to discover the IS, i.e., how to discover a location of the IS over networks. Even if the IEEE 802.21 standard develops the technology for identifying how to discover the location of the IS over networks, the technology defines only how to receive handover information from the IS.

FIG. 3 is a block diagram of an apparatus 100 for discovering a location of an information server according to an exemplary embodiment of the present invention. Referring to FIG. 3, the apparatus 100 for discovering the location of the IS may comprise a request message transmitting unit 110, a router advertisement (RA) receiving unit 120, and a location information extracting unit 130.

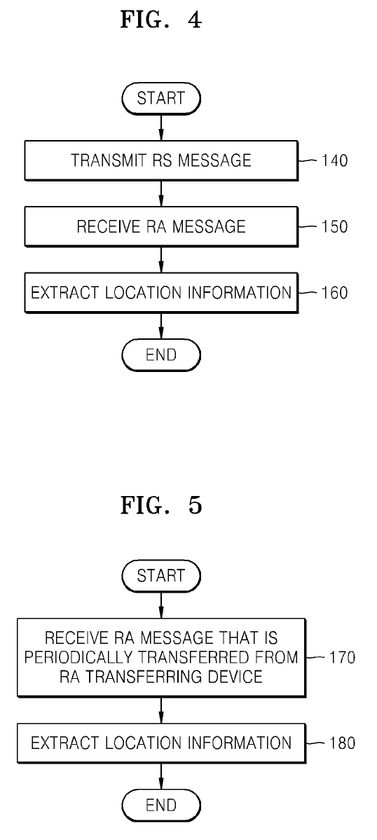

FIG. 4 is a flowchart of a method of discovering a location of an information server according to an exemplary embodiment of the present invention. Referring to FIG. 4, the request message transmitting unit 110 transmits a router solicitation (RS) message requesting location information on the IS from an MN to an RA transferring device (Operation 140).

The RA receiving unit 120 receives an RA message from the RA transferring device in response to the RS message (Operation 150).

The location information extracting unit 130 extracts the location information on the IS over a network from the RA message (Operation 160).

The RA transferring device transfers the RA message in response to the RS message or periodically transmits the RA message to the RA receiving unit 120.

FIG. 5 is a flowchart of a method of discovering a location of an information server according to another exemplary embodiment of the present invention. Referring to FIG. 5, the RA receiving unit 120 receives the RA message that is periodically transmitted from the RA transferring device (Operation 170).

The location information extracting unit 130 extracts the location information on the IS over the network from the RA message (Operation 180).

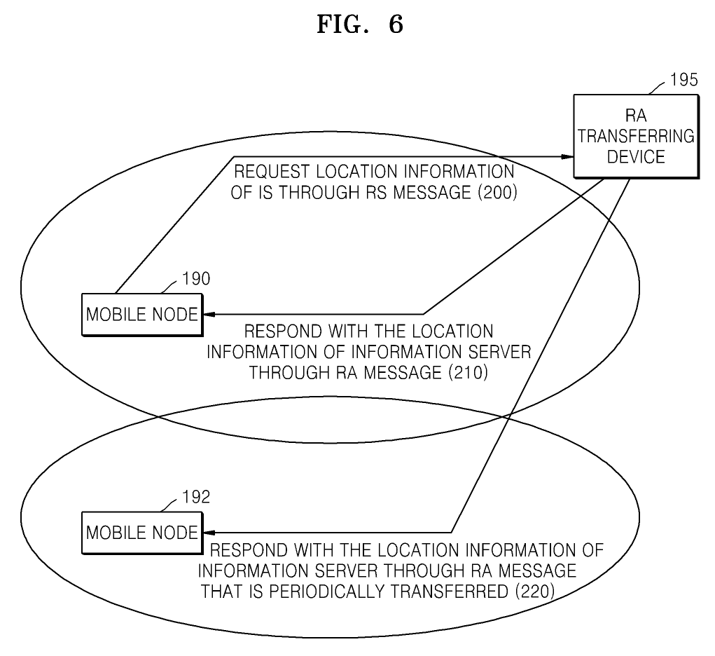

FIG. 6 illustrates a mobile communication environment in which a location of an information server is discovered according to an exemplary embodiment of the present invention.

In an Internet protocol version 6 (IPv6) environment an RA message is used to provide an MN with information necessary for setting an IPv6 address. The RA message including a DNS server address is also provided to the MN. Therefore, the RA message may transfer location information on an IS over a network via the RA message.

An RA transferring device transmits the RA message to the MN. An RA transferring device 195 of the present embodiment transfers the RA message including the location information on the IS to MNs 190 and 192. An access router of an IPv6 network generally serves as the RA transferring device 195 but the present invention is not necessarily limited thereto. The RA transferring device 195 may be a device that transfers an RA message including location information on an IS to an MN.

The RA transferring device 195 transfers the RA message to the MNs 190 and 192 by using one of the following two methods.

First Method: when the MN 190 receives handover information in a network to which the MN 190 belongs or a new network, the MN 190 transmits an RS message requesting the location information on the IS to the RA transferring device 195 (Operation 200). The RA transferring device 195 receives the RS message and transfers the RA message including the location information on the IS over the network in response to the RS message (Operation 210).

Second Method: the RA transferring device 190 periodically transfers the RA message at a predetermined time interval (Operation 220). Therefore, the MN 190 can receive the RA message that is periodically transferred from the RA transferring device 190.

The MN 190 extracts the location information on the IS from the RA message and receives information necessary for determining mobility from the IS by using the location information and one of the two methods.

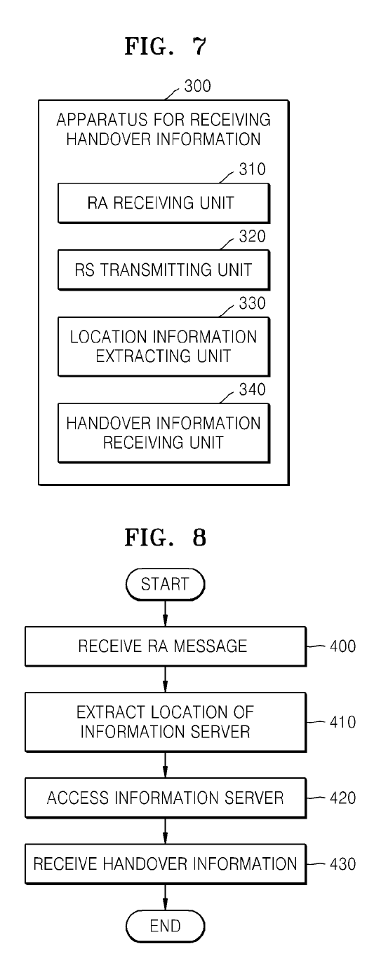

An apparatus and method for discovering a location of an IS by using an RA message and receiving handover information using the location will now be described with reference to FIGS. 7 and 8.

FIG. 7 is a block diagram of an apparatus 300 for receiving handover information according to an exemplary embodiment of the present invention. FIG. 8 is a flowchart of a method of receiving handover information according to an exemplary embodiment of the present invention.

Referring to FIG. 7, the apparatus 300 for receiving handover information may comprise an RA receiving unit 310, an RS transmitting unit 320, a location information extracting unit 330, and a handover information receiving unit 340.

The RA receiving unit 310 receives the RA message including location information on an IS from an RA transferring device (Operation 400). The RA transferring device transfers the RA message by using one of the two methods as described with reference to FIG. 6.

In the first method, the RS transmitting unit 320 transmits an RS message requesting the location information on the IS to the RA transferring device. The RA receiving unit 310 receives the RA message transmitted from the RA transferring device in response to the RS message.

In the second method, the RA receiving unit 310 receives the RA message that is periodically transferred from the RA transferring device.

The location information extracting unit 330 extracts the location information on the IS from the RA message (Operation 410).

The handover information receiving unit 340 accesses the IS by using the location information on the IS (Operation 420), and receives handover information from the IS (Operation 430).

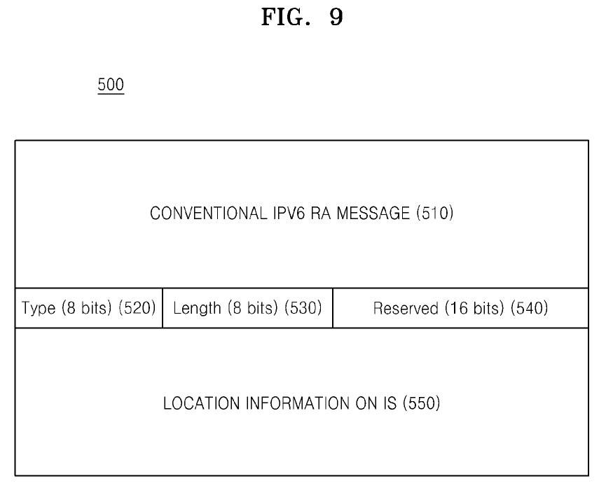

FIG. 9 is a diagram of a format of an RA message 500 according to an exemplary embodiment of the present invention. Referring to FIG. 9, the RA message 500 further includes a location information option compared to a conventional IPv6 RA message 510.

The location information option includes a type field 520, a length field 530, and a location information field 550. The location information option may further include a reserved field 540 in order to prepare for a change in the future specification.

The type field 520 indicates that an additional option is the location information option.

The length field 530 indicates the length of location information.

The location information field 550 includes location information on an IS over a network.

Exemplary embodiments of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and the like.

In an IPv6 environment, a mobile terminal receives information necessary for setting an address and communicating through an RA message. Therefore, the RA message needs to be transferred in all IPv6 environments. The RA message transfers location information on an information server over a network, which does not need additional technology in order to transfer the location information on the information server. Furthermore, the mobile terminal first sets the address using the RA message before performing another operation. Therefore, an exemplary embodiment of the present invention can acquire the location information on the information server and receive handover information from the information server, thereby performing an efficient handover without an unnecessary time delay.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of discovering a location of an information server that provides a mobile node with handover information over a network, the method comprising:
receiving a router advertisement (RA) message including location information on the information server over the network; and
extracting the location information on the information server over the network from the RA message.

2. The method of claim 1, wherein the receiving of the RA message comprises:
transmitting a router solicitation (RS) message requesting the location information on the information server to an RA transferring device from the mobile node; and
receiving the RA message from the RA transferring device in response to the RS message.

3. The method of claim 1, wherein the receiving of the RA message comprises:
receiving the RA message that is periodically transferred from an RA transferring device.

4. The method of claim 1, wherein the RA message includes an option indicating the location information,
wherein the location information option comprises:
a type field indicating that the option is the location information option;
a length field indicating the length of the location information; and
a location information field containing the location information.

5. An apparatus for discovering a location of an information server that provides handover information over a network, the apparatus comprising:
a router advertisement (RA) receiving unit which receives an RA message including location information on the information server over the network; and
a location information extracting unit which extracts the location information on the information server over the network from the RA message.

6. The apparatus of claim 5, further comprising:
a router solicitation (RS) transmitting unit which transmits an RS message requesting the location information on the information server to an RA transferring device from the mobile node,
wherein the RA receiving unit receives the RA message from the RA transferring device in response to the RS message.

7. The apparatus of claim 5, wherein the RA receiving unit receives the RA message that is periodically transferred from an RA transferring device.

8. The apparatus of claim 5, wherein the RA message includes an option indicating the location information,
wherein the location information option comprises:
a type field indicating that the option is the location information option;
a length field indicating the length of the location information; and
a location information field containing the location information.

9. A method of receiving handover information in a mobile node, the method comprising:
receiving a router advertisement (RA) message including location information on an information server that provides the handover information over the network;
extracting the location information on the information server over the network from the RA message;
accessing the information server by using the location information on the information server; and
receiving the handover information from the information server.

10. The method of claim 9, wherein the receiving of the RA message comprises:
transmitting a router solicitation (RS) message requesting the location information on the information server to an RA transferring device from the mobile node; and
receiving the RA message from the RA transferring device in response to the RS message.

11. The method of claim 9, wherein the receiving of the RA message comprises:
receiving the RA message that is periodically transferred from an RA transferring device.

12. The method of claim 9, wherein the RA message includes an option indicating the location information,
wherein the location information option comprises:
a type field indicating that the option is the location information option;
a length field indicating the length of the location information; and
a location information field containing the location information.

13. An apparatus for receiving handover information comprising:
a router advertisement (RA) receiving unit which receives an RA message including location information on an information server that provides the handover information over the network;
a location information extracting unit which extracts the location information on the information server over the network from the router advertisement message; and
a handover information receiving unit which accesses the information server by using the location information on the information server, and which receives the handover information from the information server.

14. The apparatus of claim 13, further comprising:
a router solicitation (RS) transmitting unit which transmits an router solicitation message requesting the location information on the information server to an RA transferring device from the mobile node,
wherein the RA receiving unit receives the RA message from the RA transferring device in response to the RS message.

15. The apparatus of claim 13, wherein the RA receiving unit receives the RA message that is periodically transferred from an RA transferring device.

16. The apparatus of claim 13, wherein the RA message includes an option indicating the location information,
wherein the location information option comprises:
a type field indicating that the option is the location information option;
a length field indicating the length of the location information; and
a location information field including the location information.

17. A computer readable recording medium having stored thereon computer executable code that enable a computer to execute a method of discovering a location of an information server that provides a mobile node with handover information over a network, the method comprising:
receiving a router advertisement (RA) message including location information on the information server over the network; and
extracting the location information on the information server over the network from the RA message.

18. A computer readable recording medium having stored thereon computer executable code that enable a computer to execute a method of receiving handover information in a mobile node, the method comprising:
receiving an RA message including location information on an information server that provides the handover information over the network;
extracting the location information on the information server over the network from the RA message;
accessing the information server by using the location information on the information server; and
receiving the handover information from the information server.
